(19) United States
(12) Patent Application Publication
(10) Pub. No.: US 2026/0237162 A1
(43) Pub. Date: Aug. 13, 2026

(54) ELECTRONIC DEVICE, CONTROL METHOD, AND NON-TRANSITORY COMPUTER READABLE STORAGE MEDIUM

(71) Applicant: HTC Corporation, Taoyuan City (TW)

(72) Inventors: Yu-Xiang WANG, Taoyuan City (TW); Tun-Hao CHAO, Taoyuan City (TW)

(21) Appl. No.: 19/051,139

(22) Filed: Feb. 11, 2025

(51) Int. Cl. G06T 19/00; G06T 7/33; G06T 7/50; G06T 7/73; G06T 19/20

(52) U.S. Cl. CPC G06T 19/006; G06T 7/33; G06T 7/50; G06T 7/73; G06T 19/20; G06T 2207/10016; G06T 2219/2004; G06T 2219/2016

(57) ABSTRACT

An electronic device is disclosed. The electronic device includes a memory, a camera circuit, a processor, and a display circuit. The memory is configured to store a spatial video embedded with several background feature points. The camera circuit is configured to capture an image of a current scene of a real space. The processor is coupled to the memory and the camera circuit. The processor is configured to position the spatial video to the image of the current scene of the real space according to the several background feature points when several feature points of the image matches the several background feature points. The display circuit is coupled to the processer. The display circuit is configured to display the spatial video.

### FIELD OF INVENTION

The present application relates to an electronic device, a control method, and a non-transitory computer readable storage medium. More particularly, the present application relates to an electronic device, a control method, and a non-transitory computer readable storage medium for recording and displaying a spatial video.

### BACKGROUND

Current spatial video/image technologies can record three-dimensional videos/images. However, they can only be played at arbitrary positions in space, which prevents them from integrating seamlessly with the background scene at the time of playback, thereby failing to provide a higher level of immersive experience.

### SUMMARY

The disclosure provides an electronic device. The electronic device includes a memory, a camera circuit, a processor, and a display circuit. The memory is configured to store a spatial video embedded with several background feature points. The camera circuit is configured to capture an image of a current scene of a real space. The processor is coupled to the memory and the camera circuit. The processor is configured to position the spatial video to the image of the current scene of the real space according to the several background feature points when several feature points of the image matches the several background feature points. The display circuit is coupled to the processer. The display circuit is configured to display the spatial video.

The disclosure provides a control method. The control method is suitable for an electronic device including a memory, a camera circuit, a processor and a display circuit. The control method includes the following operations: storing a spatial video embedded with several background feature points by the memory; capturing an image of a current scene of a real space by the camera circuit; positioning the spatial video to the image of the current scene of the real space according to the several background feature points by the processor when several feature points of the image matches the several background feature points by the processor; and displaying the spatial video by the display circuit.

The disclosure provides a non-transitory computer readable storage medium with a computer program to execute aforesaid control method.

It is to be understood that both the foregoing general description and the following detailed description are by examples and are intended to provide further explanation of the invention as claimed.

### BRIEF DESCRIPTION OF THE DRAWINGS

Aspects of the present disclosure are best understood from the following detailed description when read with the accompanying figures. It is noted that, according to the standard practice in the industry, various features are not drawn to scale. In fact, the dimensions of the various features may be arbitrarily increased or reduced for clarity of discussion.

FIG. 1 is a schematic block diagram illustrating an electronic device in accordance with some embodiments of the present disclosure.

FIG. 2 is a flowchart illustrating a control method in accordance with some embodiments of the present disclosure.

FIG. 3 is a flowchart illustrating an operation in FIG. 2 in accordance with some embodiments of the present disclosure.

FIG. 4 is a schematic diagram illustrating a user operating the electronic device in a real space in accordance with some embodiments of the present disclosure.

FIG. 5 is a schematic diagram illustrating an example of a background image and a spatial video in accordance with some embodiments of the present disclosure.

FIG. 6 is a schematic diagram illustrating an example of another background image and a spatial video in accordance with some embodiments of the present disclosure.

FIG. 7 is a schematic diagram illustrating an example of several key frames of the spatial video in accordance with some embodiments of the present disclosure.

FIG. 8 is a flowchart illustrating an operation in FIG. 2 in accordance with some embodiments of the present disclosure.

FIG. 9 is a schematic diagram illustrating an image of the current scene of the real space in accordance with some embodiments of the present disclosure.

FIG. 10 is a schematic diagram illustrating a spatial video displayed by the electronic device in accordance with some embodiments of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

It will be understood that, in the description herein and throughout the claims that follow, although the terms “first,” “second,” etc. may be used to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, the terms “comprise” or “comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

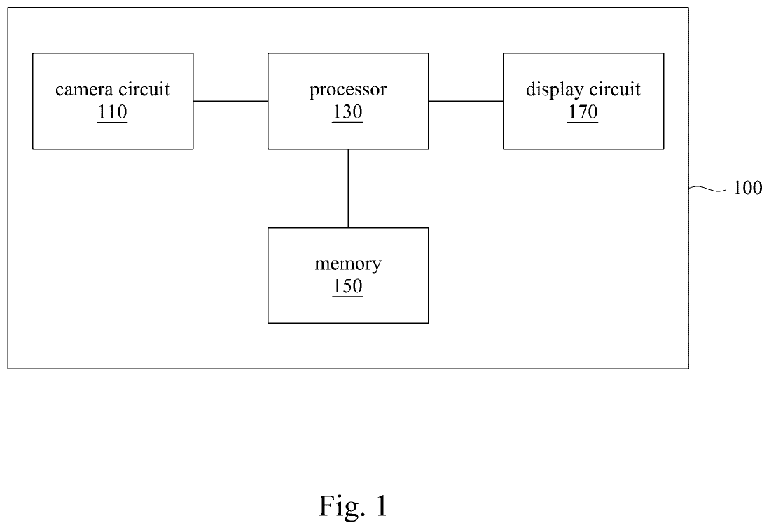

Reference is made to FIG. 1. FIG. 1 is a schematic block diagram illustrating an electronic device 100 in accordance with some embodiments of the present disclosure. As illustrated in FIG. 1, in some embodiments, electronic device 100 includes a camera circuit 110, a processor 130, a memory 150, and a display circuit 170. The processor 130 is coupled to the camera circuit 110, the memory 150 is coupled to the processor 130, and the display circuit 170 is coupled to the processor 130. The electronic device 100 as illustrated in FIG. 1 is for illustrative purposes only, and the embodiments of the present disclosure are not limited thereto.

In some embodiments, the electronic device 100 may be applied in a virtual reality (VR) system or a mixed reality (MR) system. For example, the electronic device 100 may be realized by, a standalone head mounted device (HMD). In some embodiments, the display circuit 170 covers the vision of the user.

In some embodiments, one or more programs are stored in the memory 150 and configured to be executed by the processor 130, in order to perform the control method. In some embodiments, the memory includes one or more memory devices, each of which includes, or a plurality of which collectively include a computer readable storage medium. The computer readable storage medium may include a read-only memory (ROM), a flash memory, a floppy disk, a hard disk, an optical disc, a flash disk, a flash drive, a tape, a database accessible from a network, and/or any storage medium with the same functionality that can be contemplated by persons of ordinary skill in the art to which this disclosure pertains.

In some embodiments, the processor 130 can be realized by, for example, one or more processing circuits, such as central processing circuits and/or micro processing circuits, but are not limited in this regard.

The camera circuit 110 is configured to capture one or more images of the real space that the electronic device 100 is operated in. In some embodiments, the camera circuit 110 may be realized by a camera circuit device or any other camera circuit with image capture functions.

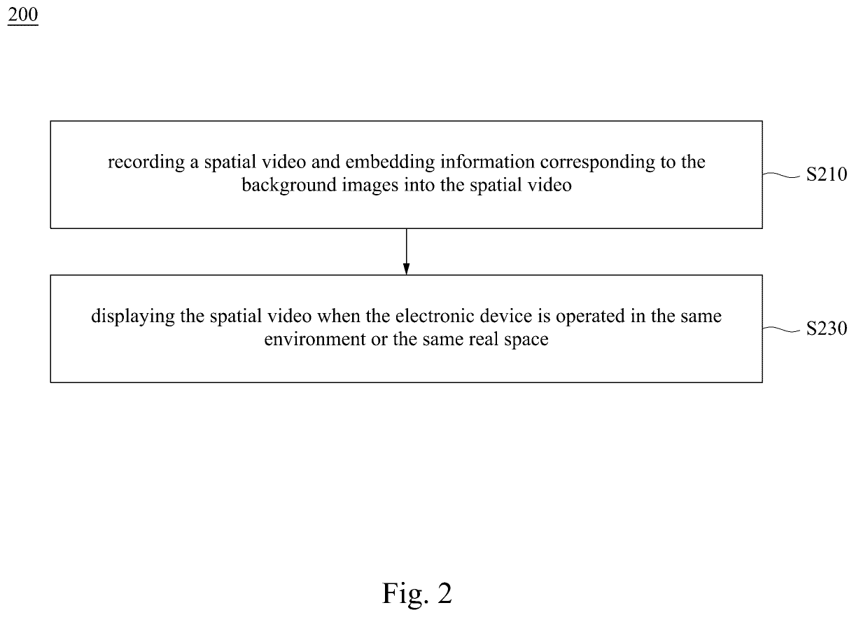

Reference is made to FIG. 2. FIG. 2 is a flowchart illustrating a control method 200 in accordance with some embodiments of the present disclosure. For better understanding of the present disclosure, the detailed operation of the electronic device 100 will be discussed in accompanying with the embodiments shown in FIG. 2. FIG. 2 is a flowchart illustrating the control method 200 in accordance with some embodiments of the present disclosure. It should be noted that the control method 200 can be applied to an electrical device having a structure that is the same as or similar to the structure of the electronic device 100 shown in FIG. 1. To simplify the description below, the embodiments shown in FIG. 1 will be used as an example to describe the control method 200 according to some embodiments of the present disclosure. However, the present disclosure is not limited to application to the embodiments shown in FIG. 1. As shown in FIG. 2, the control method 200 includes operations S210 and S230.

In operation S210, a spatial video is recorded and information corresponding to the background images is embedded into the spatial video.

In operation S230, the spatial video is displayed when the electronic device is operated in the same environment or the same real space.

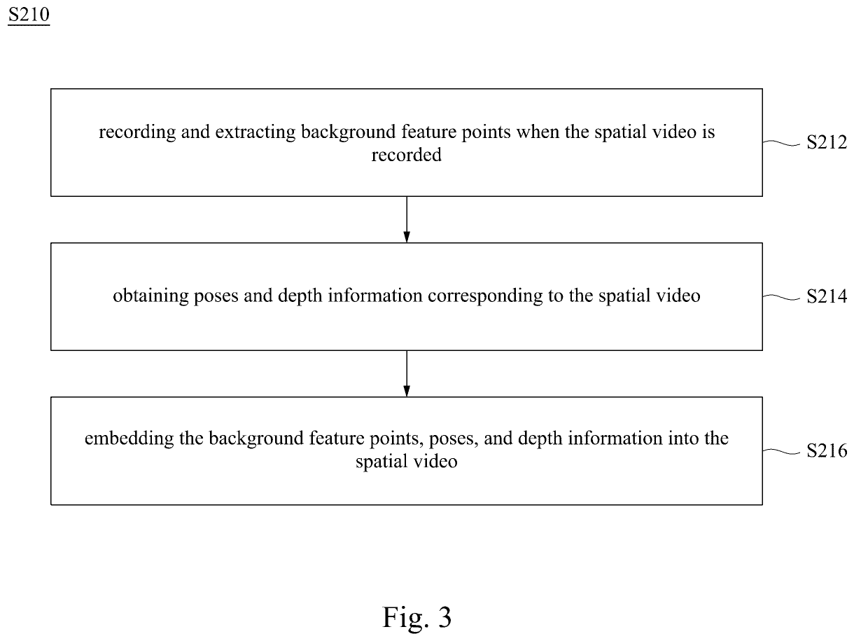

Reference is made to FIG. 3 together. FIG. 3 is a flowchart illustrating operation S210 in FIG. 2 in accordance with some embodiments of the present disclosure. Operation S210 includes operations S212 to S216.

In operation S212, background feature points are extracted and recorded when the spatial video is recorded.

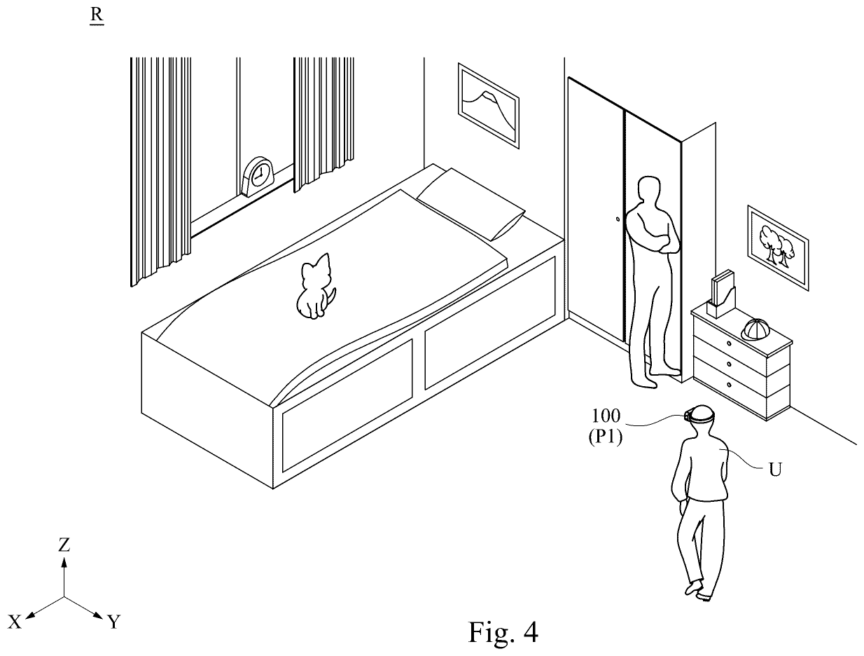

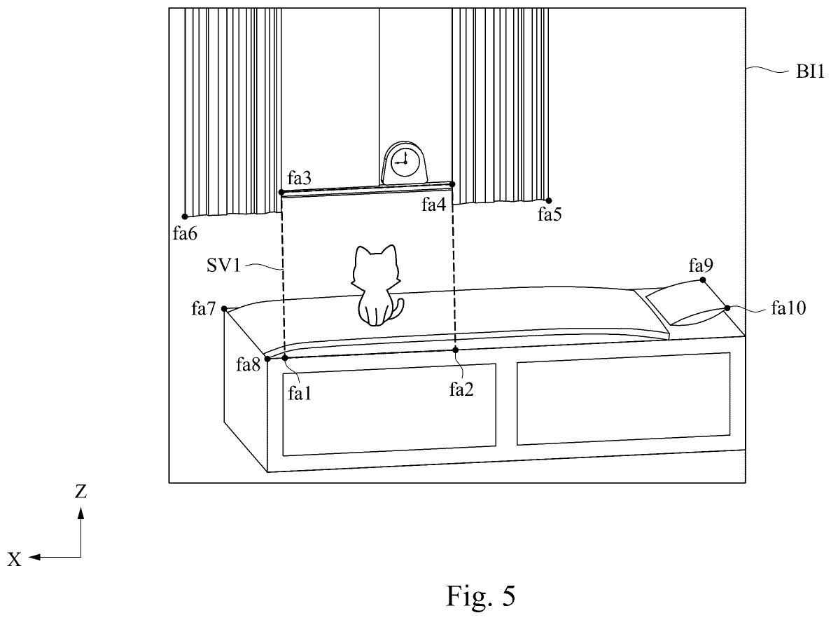

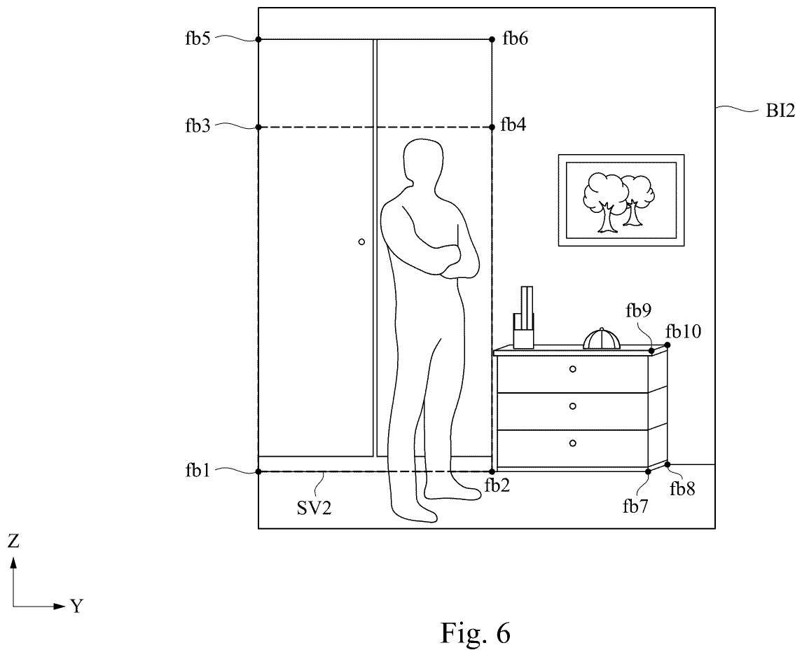

Reference is made to FIG. 4 to FIG. 6 together. FIG. 4 is a schematic diagram illustrating a user U operating the electronic device 100 in a real space R in accordance with some embodiments of the present disclosure. FIG. 5 is a schematic diagram illustrating an example of a background image BI1 and a spatial video SV1 in accordance with some embodiments of the present disclosure. FIG. 6 is another schematic diagram illustrating another example of another background image BI2 and a spatial video SP2 in accordance with some embodiments of the present disclosure.

The spatial video SV1 and the background image BI1 as illustrated in FIG. 5 are recorded and captured simultaneously by the camera circuit 110 as illustrated in FIG. 1 when the electronic device 100 is operated at the pose P1 in the real space R as illustrated in FIG. 4.

As illustrated in FIG. 5, according to the background image BI1, the processor 130 as illustrated in FIG. 1 extracts several background feature points fa1 to fa10 according to the background image BI1.

In some embodiments, when recording the spatial video, the electronic device 100 as illustrated in FIG. 4 moves from pose P1 to another pose (not shown) in the real space R, and the camera circuit 110 as illustrated in FIG. 1 records and captures the spatial video SV2 and the background image BI2 as illustrated in FIG. 6 simultaneously. In some embodiments, at pose P1, the background image BI1 of the current scene of the real space R includes the XZ plane. At another pose, the background image BI2 of the current scene of the real space R includes the YZ plane.

As illustrated in FIG. 6, according to the background image BI2, the processor 130 as illustrated in FIG. 1 extracts several background feature points fb1 to fb10 according to the background image BI2.

In operation S214, poses and depth information corresponding to the spatial video are obtained. Reference is made to FIG. 5 and FIG. 6 together. In some embodiments, when recording the spatial video, the depth information of the spatial video and the pose of the electronic device 100 in the real space R are obtained by the processor 130.

In some embodiments, the depth information of the spatial video is obtained by a depth sensor (not shown) of the electronic device 100.

In some embodiments, the pose refers to the SLAM pose in a SLAM map constructed by the electronic device 100 in correspondence to the real space R.

In operation S216, the background feature points, poses, and depth information are embedded into the spatial video. In some embodiments, operation S216 is operated by the processor 130 as illustrated in FIG. 1.

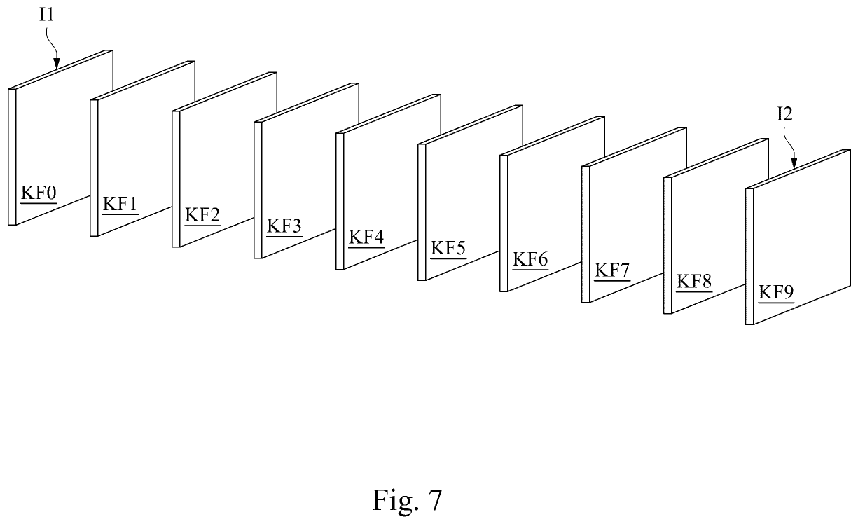

Reference is made to FIG. 7 together. FIG. 7 is a schematic diagram illustrating an example of several key frames KF0 to KF9 of the spatial video SV in accordance with some embodiments of the present disclosure. Assume that the spatial video SV includes the spatial video SV1 as illustrated in FIG. 5 and the spatial video SV2 as illustrated in FIG. 6. The spatial video SV1 includes the key frames KF0 to KF8 and starts with the key frame KF0, and the spatial video SV2 starts with the key frame KF9.

In some embodiments, the processor 130 embeds the information I1 corresponding to the background image BI1 and the spatial video SV1 as illustrated in FIG. 5 into the key frame KF0 of the spatial video SV. The information I1 includes the background feature points fa1 to fa10, the depth information, and/or the pose of the electronic device 100.

Similarly, the processor 130 embeds the information I2 corresponding to the background image BI2 and the spatial video SV2 as illustrated in FIG. 5 into the key frame KF9 of the spatial video SV. The information I2 includes the background feature points fb1 to fb10, the depth information, and/or the pose of the electronic device 100.

In some embodiments the spatial video SV with the embedded information is stored in the memory 150 as illustrated in FIG. 1.

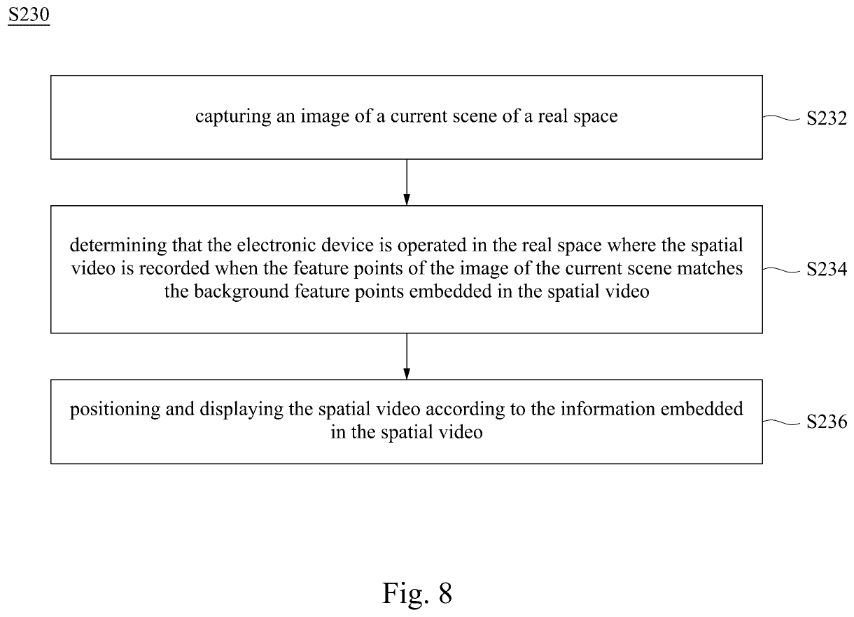

Reference is made to FIG. 8 together. FIG. 8 is a flowchart illustrating operation S230 in FIG. 2 in accordance with some embodiments of the present disclosure. Operation S230 includes operations S232 to S236.

In some embodiments, in operation S230, the user U (or another user) operates the electronic device 100 in the real space R again and intends to display the previously recorded spatial video SV.

In operation S232, an image of a current scene of a real space is captured. In some embodiments, operation S232 is performed by the camera circuit 110 as illustrated in FIG. 1.

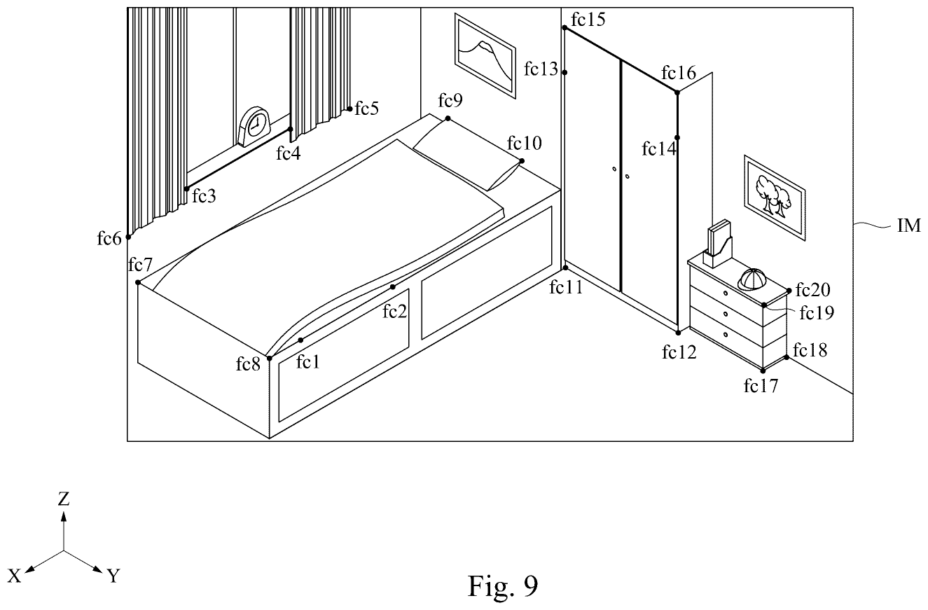

Reference is made to FIG. 9 together. FIG. 9 is a schematic diagram illustrating an image IM of the current scene of the real space R in accordance with some embodiments of the present disclosure.

According to the image IM, the processor 130 as illustrated in FIG. 1 obtains several feature points fc1 to fc20.

In operation S234, it is determined that the electronic device is operated in the real space where the spatial video is recorded when the feature points of the image of the current scene matches the background feature points embedded in the spatial video. In some embodiments, operation S234 is performed by the processor 130 as illustrated in FIG. 1.

For example, in some embodiments, the feature points fc1 to fc20 match the background feature points fa1 to fa10 and the background feature points fb1 to fb10, the processor determines that the feature points of the image IM as illustrated in FIG. 9 matches the background feature points of the spatial video SV as illustrated in FIG. 7 successfully. Therefore, the processor 130 determines that the electronic device 100 is operating in the same real space R where the spatial video SV is recorded.

Several feature matching methods are included within the scope of the present disclosure and would not be described in detail herein.

On the other hand, in some other embodiments, if the user U is not operating the electronic device 100 in another real space as illustrated in FIG. 4 in operation S230, the feature points of the image of the current scene of the another real space do not match the background feature points of the spatial video SV successfully, and the processor 130 determines that the electronic device is not operating in the same real space R where the spatial video SV is recorded.

In operation S236, the spatial video is positioned and displayed according to the information embedded in the spatial video. In some embodiments, the operation S236 is performed by the processor 130 as illustrated in FIG. 1.

In some embodiments, the spatial video SV is positioned, resized, and displayed according to the background feature points, the deep information, and/or the poses embedded in the spatial video SV.

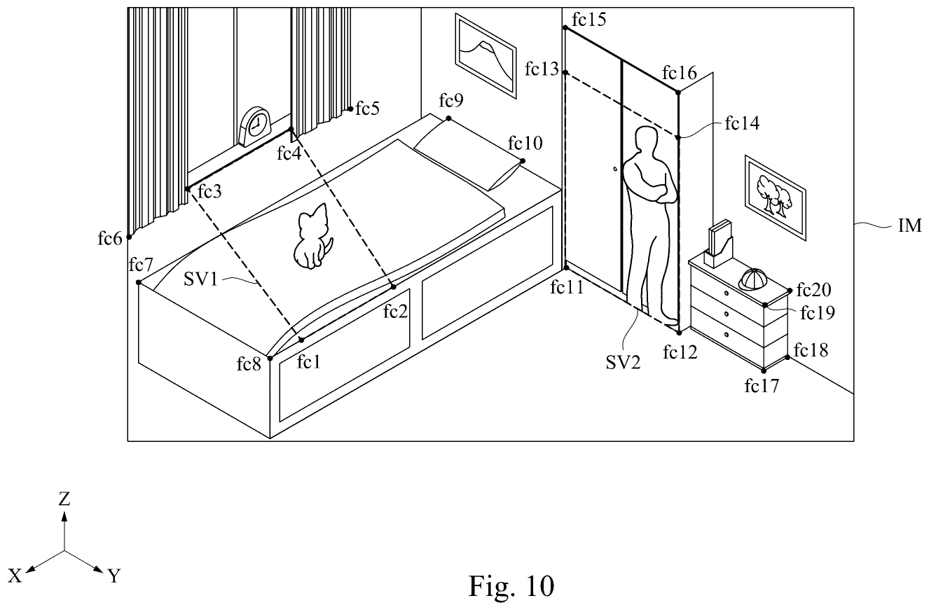

Reference is made to FIG. 10 together. FIG. 10 is a schematic diagram illustrating the spatial video SV1 and the spatial video SV2 displayed by the electronic device 100 in accordance with some embodiments of the present disclosure.

Reference is made to FIG. 7 together. In some embodiments, when the key frame KF0 is displayed, the processor 130 matches the spatial video SV1 to the feature points fc1 to fc4 according to the background feature points fa1 to fa4 embedded in the key frame KF0, since the feature points fc1 to fc4 matches the background feature points fa1 to fa4. In some embodiments, the boundary of the spatial video SV1 is determined by the feature points fc1 to fc4.

Similarly, when the key frame KF9 is displayed, the processor 130 matches the spatial video SV2 to the feature points fc11 to fc14 according to the background feature points fb1 to fb4 embedded in the key frame KF9, since the feature points fc11 to fc14 matches the background feature points fb1 to fb4. In some embodiments, the boundary of the spatial video SV2 is determined by the feature points fc11 to fc14.

In some embodiments, when matching the boundary of the spatial video to the feature points, the spatial video is resized and positioned to the image of the current scene of the real space according to the feature points accordingly.

In some embodiments, in operation S230, the user U may only looks at the XZ plane or the YZ plane of the real space R. In some other embodiments, the user U may looks toward arbitrary directions of the real space R. According to the image captured by the camera circuit 110 in operation S232, the processor 130 performs operations S234 and S236 according to the image captured in operation S232 in real time.

In some embodiments, in operation S236, the positioned spatial video is then rendered by the processor 130 and displayed on the image IM of the current scene of the real space R by the display circuit 170 as illustrated in FIG. 1.

In some embodiments, in operation S230, the processor 130 obtains the SLAM pose of the user U, and the processor 130 further resized and positioned the spatial video SV1 and the spatial video SV2 according to the SLAM pose of the user U. For example, in an embodiment, the processor 130 resized and positioned the spatial video SV1 according to a relative position and a relative rotation between the pose of the user U in operation S230 and the pose embedded into the key frame corresponding to the spatial video in operation S210.

In some embodiments, the operation S210 and operation S230 may be performed by different electronic devices. For example, in one embodiment, after the electronic device 100 as illustrated in FIG. 1 records the spatial video and embeds the information into the spatial video as mentioned in operation S210, the electronic device 100 may transmit and store the information embedded spatial video to a cloud database or any other storage medium. Then, another electronic device with the same or similar construction or functions with that of the electronic device 100 may download the information embedded spatial video from the cloud database or the storage medium, and the another electronic device may perform operation S230 so as to display the spatial video.

The feature points/background feature points mentioned in the embodiments of the present disclosure are represent pixel locations in images and may be utilized to construct a SLAM map corresponding to the real space. In some embodiments, each of the feature points includes a coordinate point in the SLAM map.

Through the operations of various embodiments described above, an electronic device, a control method, and a non-transitory computer readable storage medium are implemented. During the recording process of spatial video, background feature points are simultaneously extracted and recorded. By combining these background feature points with information obtained from pose and depth sensors, the spatial video can be automatically positioned and re-rendered at the correct location in the real space if played back at the same environment or the same real space. This ensures alignment with the background as it was during recording when displaying the recorded spatial video. Additionally, the video window of the spatial video will move according to the movement of the headset during recording, ensuring that the background always matches the recorded scene. This creates an immersive experience, making it seem as if the video truly exists within the pass-through view.

In addition, it should be noted that in the operations of the abovementioned control method 200, no particular sequence is required unless otherwise specified. Moreover, the operations may also be performed simultaneously or the execution times thereof may at least partially overlap.

Furthermore, the operations of the control method 200 may be added to, replaced, and/or eliminated as appropriate, in accordance with various embodiments of the present disclosure.

Various functional components or blocks have been described herein. As will be appreciated by persons skilled in the art, the functional blocks will preferably be implemented through circuits (either dedicated circuits, or general purpose circuits, which operate under the control of one or more processing circuits and coded instructions), which will typically include transistors or other circuit elements that are configured in such a way as to control the operation of the circuity in accordance with the functions and operations described herein.

Although the present disclosure has been described in considerable detail with reference to certain embodiments thereof, other embodiments are possible. Therefore, the scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An electronic device, comprising:
a memory, configured to store a spatial video embedded with a plurality of background feature points;
a camera circuit, configured to capture an image of a current scene of a real space;
a processor, coupled to the memory and the camera circuit, wherein the processor is configured to position the spatial video to the image of the current scene of the real space according to the plurality of background feature points when a plurality of feature points of the image matches the plurality of background feature points; and
a display circuit, coupled to the processer, configured to display the spatial video.

2. The electronic device of claim 1, wherein the camera circuit is further configured to simultaneously record the spatial video and a plurality of background images, and wherein the processor is further configured to:
extract the plurality of background feature points according to the plurality of background images; and
embed the plurality of background feature points into the spatial video.

3. The electronic device of claim 2, wherein the electronic device moves from a first pose to a second pose when recording the spatial video, wherein the processor is further configured to:
obtain a plurality of first background feature points according to a first background image captured at the first pose, and embed the plurality of first background feature points into a first key frame of the spatial video; and
obtain a plurality of second background feature points according to a second background image captured at the second pose, and embed the plurality of second background feature points into a second key frame of the spatial video.

4. The electronic device of claim 1, wherein the processor is further configured to:
obtain a depth information of the spatial video when recording the spatial video and embed the depth information into the spatial video; and
position the spatial video to the current scene of the real space according to the depth information when displaying the spatial video.

5. The electronic device of claim 1, wherein the processor is further configured to:
obtain a pose of the electronic device when recording the spatial video and embed the pose into the spatial video.

6. The electronic device of claim 1, wherein the spatial video comprises a first key frame and a second key frame, wherein the first key frame comprises a plurality of first background feature points and the second key frame comprises a plurality of second background feature points, wherein the processor is further configured to:
position the spatial video to a first position of the current scene of the real space when displaying the first key frame; and
position the spatial video to a second position of the current scene of the real space when displaying the second key frame.

7. The electronic device of claim 1, further comprising:
resize the spatial video according to the plurality of background feature points when displaying the spatial video.

8. A control method, suitable for an electronic device comprising a memory, a camera circuit, a processor and a display circuit, wherein the control method comprises:
storing a spatial video embedded with a plurality of background feature points by the memory;
capturing an image of a current scene of a real space by the camera circuit;
positioning the spatial video to the image of the current scene of the real space according to the plurality of background feature points by the processor when a plurality of feature points of the image matches the plurality of background feature points by the processor; and
displaying the spatial video by the display circuit.

9. The control method of claim 8, further comprising:
recording the spatial video and a plurality of background images simultaneously;
extracting the plurality of background feature points according to the plurality of background images; and
embedding the plurality of background feature points into the spatial video.

10. The control method of claim 9, further comprising:
moving the electronic device from a first pose to a second pose when recording the spatial video;
obtaining a plurality of first background feature points according to a first background image captured at the first pose, and embedding the plurality of first background feature points into a first key frame of the spatial video; and
obtaining a plurality of second background feature points according to a second background image captured at the second pose, and embedding the plurality of second background feature points into a second key frame of the spatial video.

11. The control method of claim 8, further comprising:
obtaining a depth information of the spatial video when recording the spatial video and embedding the depth information into the spatial video; and
positioning the spatial video to the current scene of the real space according to the depth information when displaying the spatial video.

12. The control method of claim 8, further comprising:
obtaining a pose of the electronic device when recording the spatial video and embedding the pose into the spatial video.

13. The control method of claim 8, wherein the spatial video comprises a first key frame and a second key frame, wherein the first key frame comprises a plurality of first background feature points and the second key frame comprises a plurality of second background feature points, wherein the control method further comprises:
positioning the spatial video to a first position of the current scene of the real space when displaying the first key frame; and
positioning the spatial video to a second position of the current scene of the real space when displaying the second key frame.

14. The control method of claim 8, further comprising:
resizing the spatial video according to the plurality of background feature points when displaying the spatial video.

15. A non-transitory computer readable storage medium, wherein the non-transitory computer readable storage medium comprises one or more computer programs stored therein, and the one or more computer programs can be executed by one or more processors so as to be configured to operate a control method suitable for an electronic device comprising a memory, a camera circuit, a processor and a display circuit, wherein the control method comprises:
storing a spatial video embedded with a plurality of background feature points by the memory;
capturing an image of a current scene of a real space by the camera circuit;
positioning the spatial video to the image of the current scene of the real space according to the plurality of background feature points by the processor when a plurality of feature points of the image matches the plurality of background feature points by the processor; and
displaying the spatial video by the display circuit.

16. The non-transitory computer readable storage medium of claim 15, wherein the control method further comprises:
recording the spatial video and a plurality of background images simultaneously;
extracting the plurality of background feature points according to the plurality of background images; and
embedding the plurality of background feature points into the spatial video.

17. The non-transitory computer readable storage medium of claim 16, wherein the control method further comprises:
moving the electronic device from a first pose to a second pose when recording the spatial video;
obtaining a plurality of first background feature points according to a first background image captured at the first pose, and embedding the plurality of first background feature points into a first key frame of the spatial video; and
obtaining a plurality of second background feature points according to a second background image captured at the second pose, and embedding the plurality of second background feature points into a second key frame of the spatial video.

18. The non-transitory computer readable storage medium of claim 15, wherein the control method further comprises:
obtaining a depth information of the spatial video when recording the spatial video and embedding the depth information into the spatial video; and
positioning the spatial video to the current scene of the real space according to the depth information when displaying the spatial video.

19. The non-transitory computer readable storage medium of claim 15, wherein the control method further comprises:
obtaining a pose of the electronic device when recording the spatial video and embedding the pose into the spatial video.

20. The non-transitory computer readable storage medium of claim 15, wherein the spatial video comprises a first key frame and a second key frame, wherein the first key frame comprises a plurality of first background feature points and the second key frame comprises a plurality of second background feature points, wherein the control method further comprises:
positioning the spatial video to a first position of the current scene of the real space when displaying the first key frame; and
positioning the spatial video to a second position of the current scene of the real space when displaying the second key frame.
